(19) United States
(12) Patent Application Publication
(10) Pub. No.: US 2009/0210371 A1
(43) Pub. Date: Aug. 20, 2009

(54) DATA ADAPTIVE PREDICTION FUNCTION BASED ON CANDIDATE PREDICTION FUNCTIONS

(75) Inventor: Mark van der Laan, Orinda, CA (US)

Correspondence Address: Trellis Intellectual Property Law Group, PC, 1900 EMBARCADERO ROAD, SUITE 109, PALO ALTO, CA, 94303, US

(73) Assignee: The Regents of the University of Calfornia, Oakland, CA (US)

(21) Appl. No.: 12/371,585

(22) Filed: Feb. 14, 2009

Related U.S. Application Data
(60) Provisional application No. 61/029,279, filed on Feb. 15, 2008.

(51) Int. Cl. G06F 15/18

(52) U.S. Cl. 706/21

(57) ABSTRACT

In one embodiment, a method for predicting an outcome is provided. The method comprises: determining a known data set of data, the known data set of data including an input variable and an output variable; determining a plurality of candidate prediction functions, each prediction function adapted to determine a candidate predicted outcome for the output variable using a different algorithm; determining a combination of the plurality of candidate prediction functions based on the known data set; determining a second set of data, the second set of data including data for the input variable; and determining, based on the input variable, a predicted outcome for the output variable using a data adaptive prediction function, wherein the data adaptive prediction function uses the combination of candidate predicted outcomes from the plurality of candidate prediction functions determined using the data from the input variable to determine the predicted outcome.

### CROSS REFERENCES TO RELATED APPLICATIONS

This application claims priority from U.S. Provisional Patent Application Ser. No. 61/029,279, entitled SUPER LEARNING PREDICTION FUNCTION BASED ON CANDIDATE PREDICTION ALGORITHMS, filed on Feb. 15, 2008, which is hereby incorporated by reference as if set forth in full in this application f or all purposes.

### BACKGROUND

Particular embodiments generally relate to statistical analysis and more specifically to prediction mechanisms.

Some methods exist to learn from data the best predictor of a given outcome based on a sample of n observations. A few examples include decision trees, neural networks, support vector regression, least angle regression, logic regression, poly-class, Mars, and the Deletion/Substitution/Addition (D/S/A) algorithm. Such algorithms, or learners, can be characterized by the mechanism used to search the parameter space of possible regression functions, where a regression function is a function mapping an input variable into a predicted outcome. The performance of a particular learner depends on how effective its searching strategy is in approximating the unknown optimal predictor defined by the true data generating distribution. Thus, the relative performance of various learners will depend on the true data-generating distribution. That means that in practice one algorithm will perform well in certain applications but possibly very poor in others and therefore there is typically not a single algorithm which outperforms the others in all applications of interest. In general, it is typically impossible to know a priori which candidate estimator of a particular unknown quantity of the true data generating distribution will perform best for a given data set.

### SUMMARY

In one embodiment, a method for predicting an outcome is provided. The method comprises: determining a known data set of data, the known data set of data including an input variable and an output variable; determining a plurality of candidate prediction functions, each prediction function adapted to determine a candidate predicted outcome for the output variable using a different algorithm; determining a combination of the plurality of candidate prediction functions based on the known data set; determining a second set of data, the second set of data including data for the input variable; and determining, based on the input variable, a predicted outcome for the output variable using a data adaptive prediction function, wherein the data adaptive prediction function uses the combination of candidate predicted outcomes from the plurality of candidate prediction functions determined using the data from the input variable to determine the predicted outcome.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example of a system for determining predictions according to one embodiment.

FIG. 2 depicts an example of a training system that may be used to determine a combination of the candidate predicted outcomes.

FIG. 3 depicts a simplified flowchart of a method for selection of weights according to one embodiment.

FIG. 4 depicts a simplified system for generating data adaptive prediction function according to one embodiment.

FIG. 5 depicts a simplified flowchart of a method for determining a predicted outcome according to one embodiment.

### DETAILED DESCRIPTION OF EMBODIMENTS

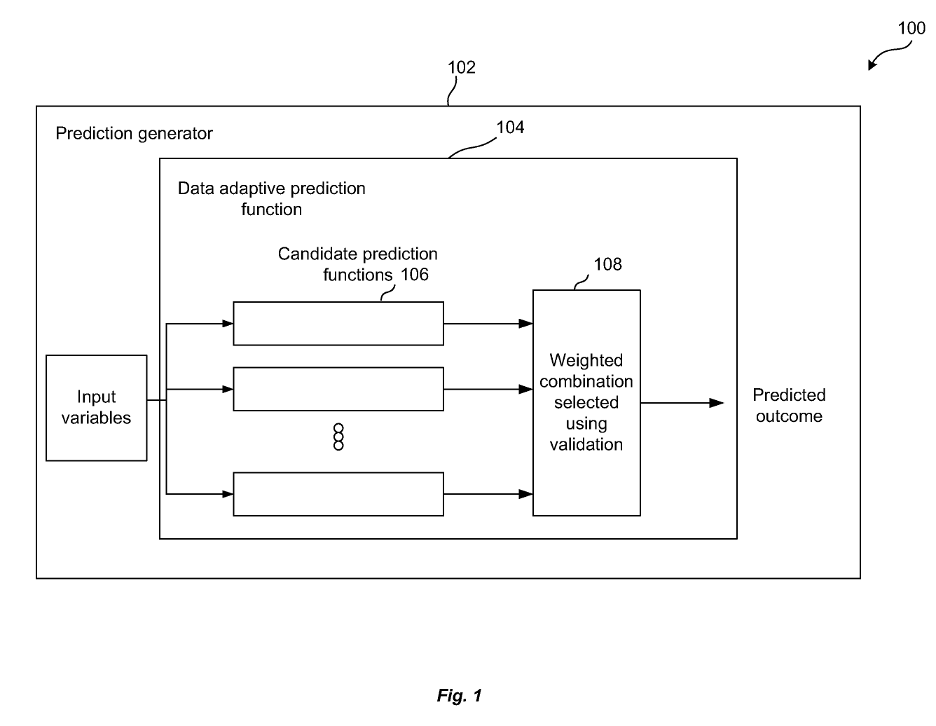

FIG. 1 depicts an example of a system 100 for determining predictions according to one embodiment. A prediction generator 102 is configured to process a data set and determine a prediction for the data set. Prediction generator 102 may be a computing device programmed to provide the prediction. Additionally, prediction generator 102 may include any number of computing devices that may operate in a distributed manner.

A data adaptive prediction function is determined that can predict an outcome based on a set of input variables from the data set. The data adaptive prediction function 104 is an estimator of a particular feature/function of the distribution of the data set. The data for the input variables is input into candidate prediction functions 106, which predict candidate outcomes. The data adaptive prediction function maps outcomes for candidate prediction algorithms into the predicted outcome. The data adaptive prediction function is determined based on observing a set of observations (e.g., a known dataset) in which each observation represents the input variables and the corresponding outcome. For example, the data adaptive prediction function predicts a cancer patient's response to treatment based on a measured set of baseline characteristics of the patient. This statistical sub-field is referred to as prediction or (nonparametric or data adaptive) regression.

The data adaptive prediction function is adaptable based on the known data set. For example, data for a known data set is analyzed. The data set may include a known set of data of input variables and known outcomes. Input variables may be variables in which data is measured, where this data varies based on the subjects. An output variable is the predicted outcome that is predicted using the data for the input variables. The data set is analyzed to determine a data adaptive prediction function that can be used to predict the outcome for another data set. In one example, the survival times (output variable) and patient characteristics (input variables) for a group of patients with a disease may be known. Data adaptive prediction function 104 may be used to predict the survival time of a new patient from a second set of patients that has the disease and for which the input variables/patient characteristics were measured. The input variables may be symptoms or conditions of different users in an experiment.

Data adaptive prediction function 104 is data adaptable because it is adjusted based on a known data set for a set of conditions, such as an experiment. By adapting the prediction function based on data that is determined for the set of conditions, it may be optimized for other data that is determined for the same set of conditions (e.g., experiment). As more data is determined for the experiment, the outcome of input variables for the data may be predicted. The set of conditions may be any controlled environment where data can be measured. Because data adaptive prediction function 104 is maximally adapted based on known data for an experiment, it is expected (and proven by theory) that an optimal prediction function may be determined for the experiment.

Referring to FIG. 1, a plurality of candidate prediction functions 106 may be provided. These candidate prediction functions 106 may be algorithms that are used to predict candidate predicted outcomes using input variables. Candidate prediction functions 106 may be different estimators of a particular feature/function of the distribution of the data. The estimator may be a function of the observable sample data that is used to estimate an unknown population parameter (which is called the estimand); an estimate is the result from the actual application of the function to a particular sample of data. Different estimators may be used, such as point estimators, interval estimators, density estimators, regression estimators, targeted maximum likelihood estimators as well as function estimators

A mapping from the candidate prediction functions 106 to data adaptive prediction function 104 may be determined based on a combiner. The combiner may be any function or value that combines the candidate predicted outcomes based on the known data set. In one embodiment, weights 108 may be determined. Weights 108 may be values that adjust outputs from candidate prediction functions 106. For example, different weighted combinations of candidate prediction functions 106 are determined. The outcomes of candidate prediction functions 106 may be weighted and combined as data adaptive prediction function 104. Based on the weighted combination, data adaptive prediction function 104 outputs a predicted outcome. The determination of the weights for the candidate prediction functions and how to combine the outcomes becomes the data adaptive prediction function. The generation of this function, which can be used to estimate a particular feature, provides a new data adaptive estimator.

In one embodiment, how to combine the candidate outcomes data adaptively is determined. For example, different outcomes for candidate prediction functions may be weighted differently. The weights are determined based on analyzing the known data set and the candidate algorithms. The weights may be used to weight candidate prediction outcomes that may be considered more relevant to the known data set. For example, certain candidate prediction functions may predict an outcome more accurately than others for different experiments. Particular embodiments data adaptively determine which candidate prediction functions 106 are the best for an experiment based on known data for the experiment and weight the candidate prediction functions accordingly.

Different methods may be used to determine the weighted combination 108. However, the weighted combination is determined based on the known data set. In one embodiment, cross-validation is used to determine weighted combination 108. In other embodiments, different methods of validation that can determine the weighted combination may be used. The validation may analyze bias and variance caused by different weighted combination. The difference between an estimator's expected value and the true value of the parameter being estimated is called the bias. The variance is one measure of statistical dispersion, averaging the squared distance of its possible values from the expected value (mean). Cross-validation will be described in more detail below.

Once weighted combination 108 has been determined using cross validation, the data adaptive prediction function may be determined. The data set may be used to train the candidate prediction functions 106. The trained candidate prediction functions 106 may be considered candidate prediction function fits. Weights are then applied to the trained candidate prediction functions to form the data adaptive prediction function. The output of the weighted candidate prediction function 106 may be combined. After data adaptive prediction function 104 has been determined, a different data set of input variables may be input into prediction generator 102. This data set may include input variables but does not include known outcomes. In this case, the predicted outcome that is output by data adaptive prediction function 104 may be a predicted outcome for the input variables. For example, a survival rates for a group that has a disease may be predicted based on the previous known data set that was used to determine the set of weights 108. The weights may set higher weights to outcomes from candidate prediction functions 106 that are considered to more accurately predict the outcomes. Accordingly, the predicted outcome for the new data set may have been optimized based on data that was generated for a similar experiment.

When the data set is input into prediction generator 102, each candidate prediction function 106 may take the input variables and generate an outcome. The outcomes that are generated from candidate prediction functions 106 are then combined by weighted combination 108. For example, the different weights that were determined are used to adjust the values of the outcomes. For example, different combinations of the weighted outcomes from the candidate prediction functions are used to determine the predicted outcome. The data adaptive prediction function may be determined based on first data set what is considered the best way to combine the outcomes to come up with the best prediction, such as the combination may be averaging, multiplying, or other methods of combining the candidate prediction outcomes. For example, the data adaptive prediction function can be an arbitrary specified mathematical function of the candidate predicted outcomes and the corresponding set of weights/adjustment numbers to be optimized based on first data set.

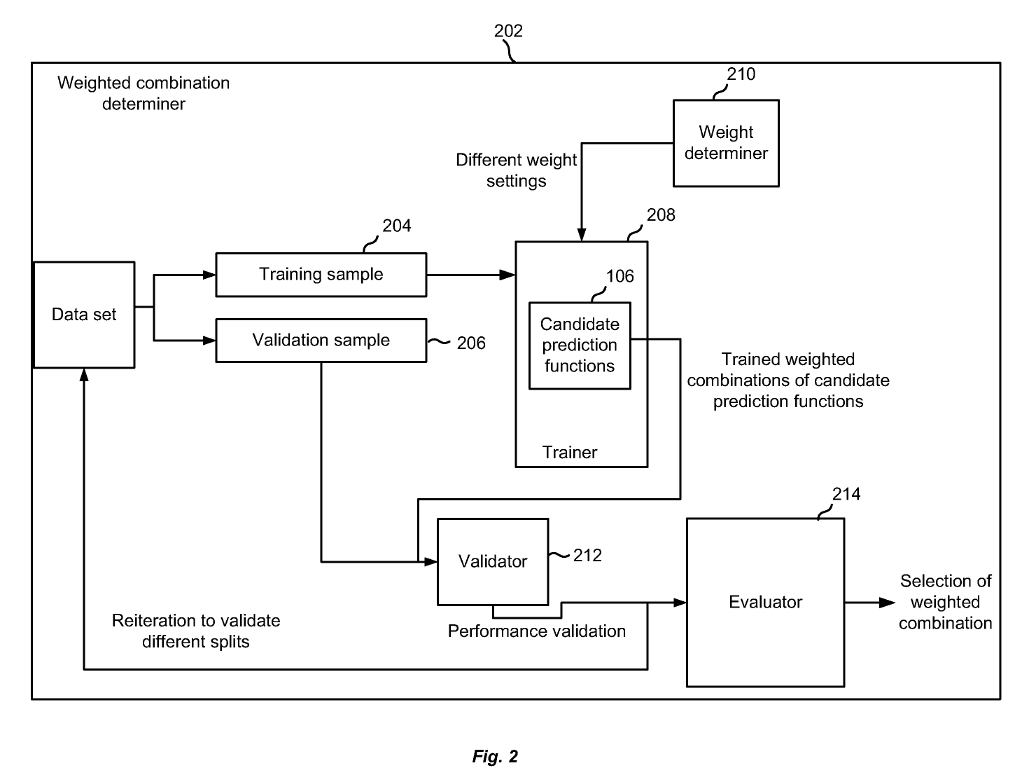

The training process will now be described in more detail. FIG. 2 depicts an example of a training system 200 that may be used to determine adjustments to the candidate predicted outcomes. For discussion purposes, a set of weights 108 is described. Also, although this training method is described, it will be understood that other training methods may be used that are based on a known data set.

A weight generator 202 is used to determine the set of weights 108. Weight generator 202 may be any number of computing devices that are programmed to determine the set of weights 108. A known data set is used to determine the weights. The known data set includes input variables and known outcomes. For example, the input variables may be data for a group of subjects with a disease. The survival indicators for the subjects in this group are also known and represent the known outcomes.

Cross-validation may be used to determine the set of weights 108. Other validation methods may be used such as any methods to access the performance of a particular weighted combination of candidate prediction functions with a particular empirical criterion (e.g., risk) based on the data, then the weights by minimizing this empirical risk. In one embodiment, V-fold cross-validation may be used as is described below. A training sample 204 and a validation sample 206 are determined from the data set. For example, the data set is divided to determine the training sample and the validation sample. In one embodiment, if there are 1000 cases in the data set, training sample 204 may include 900 of the cases and the validation sample 206 may include 100 of the cases. In addition to uses this split, V splits may be used, such as in V-fold cross-validation. V splits may be divide the training sample and validation sample differently, such as 800 cases in the training sample and 200 cases in the validation sample. The validation to determine the weights may take into account many different splits. Also, other methods for determining set of weights 108 may also be appreciated.

The set of candidate prediction functions 104 are functions that map a data set into a prediction function 104 that can be used to predict an outcome given a known input variable. If the candidate prediction functions 106 are applied to the whole data set, then this results in a particular prediction function. When doing cross-validation, the candidate prediction functions 106 are applied to training sample 204, and the remaining validation sample 206 is reserved for assessing performance of different weighted combinations of the candidate prediction functions 106 that were only trained on the training sample. The data adaptive prediction function 104 combines the candidate prediction functions 106 (as obtained by applying the candidate prediction functions 106 to the whole data set) with the weighted combination into a new prediction function. The weighted combination is chosen to optimize the performance of the data adaptive prediction function 104 based on the data set by using cross-validation. To obtain these weights candidate prediction functions 106 are trained on training sample 204, and for each possible set of weights, the performance of the weight-specific prediction function (from the training sample) on the (with the training sample corresponding) validation sample is evaluated, and the weighted combination that optimizes the performance on the validation sample of this weight specific prediction function, across several splits in training and validation sample, is selected.

A trainer 208 is used to train candidate prediction functions 106. In one example, a weight determiner 210 is used to determine different weighted combination. These weights are used to weight the outcomes of candidate prediction functions 106 differently. The weights may be determined using any method. For example, different combinations of weights may be tested. Trainer 208 then uses training sample 204, i.e., the input variables and output variables from training sample 204, to train the candidate prediction functions. The outputs of candidate prediction functions are adjusted based on the selection of weights. The trained candidate prediction functions are based on training sample 204 and the selected weights, and not the whole data set. The training process uses data in training sample 204 to output trained candidate prediction functions, which map the data into a prediction function. The candidate prediction functions may be algorithms or estimators that are programmed to predict an output. Without data, these algorithms may be generic estimators. When trained with a data set, the estimators are programmed to estimate an outcome based on the data set. For example, the prediction function may map data into a function of the dose of medicine to predict an outcome. From the data, the function may yield that three times the dosage predicts a blood pressure.

The trained candidate prediction functions are then input into a validator 212. Validator 212 is configured to validate the performance of different weighted combinations of the candidate prediction functions trained on training sample 204, using validation sample 206. In this case, the input variables from validation sample 206 may be input into the trained candidate prediction functions. The outputs of the trained candidate prediction functions are then determined. Because validation sample 206 includes known outcomes, the known outcomes are compared to the predicted outcomes output by the trained candidate prediction function.

An evaluator 214 takes the known outcomes from validation sample 206 and the predicted outcomes and determines if the selection of weights is optimal. For example, the selection of the weighted combination that yields the predicted outcomes closest to the known outcomes may be chosen.

The process described above is reiteratively performed using different weights determined by weight determiner 210. In this case, different combinations of the trained candidate prediction functions are determined using different weighted combinations. The different weighted combinations of the trained candidate prediction functions are validated by validator 212, based on the validation sample. The set of results is then evaluated by evaluator 214, which then selects the weights that are determined to provide the optimal prediction performance for the weighted combinations of the trained candidate prediction functions 106 based on the validation sample 206. The optimal prediction performance may be achieved by the set of weights that yielded the closest predicted outcomes to the known outcomes of validation sample 206.

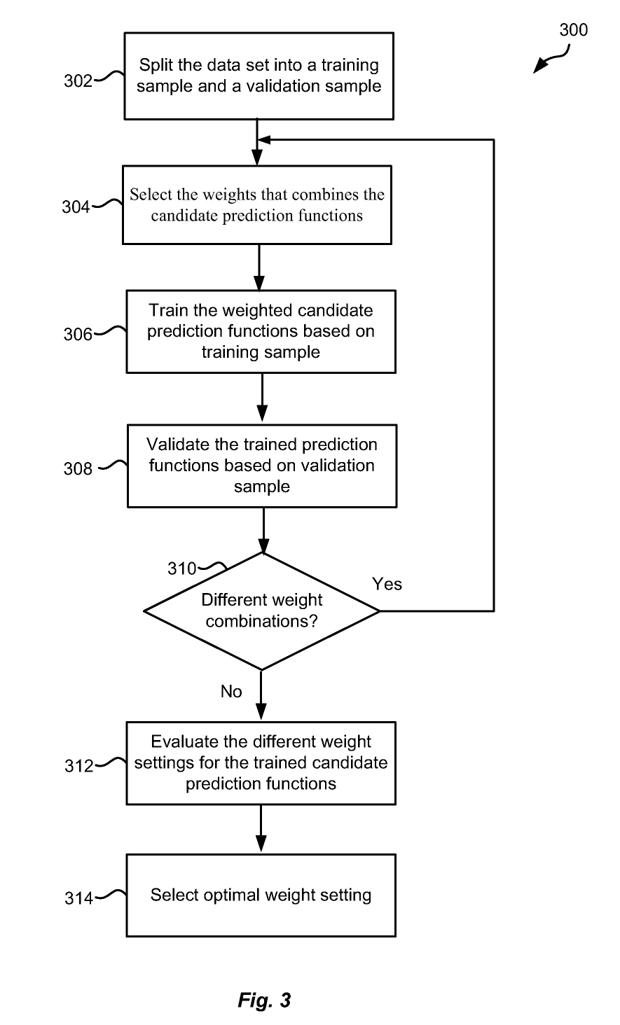

FIG. 3 depicts a simplified flowchart 300 of a method for selection of weights according to one embodiment. The method in FIG. 3 may be performed by weight generator 202.

Step 302 splits the data set into a training sample and a validation sample. Step 304 then select the weights that combine the candidate prediction functions. The weights may be selected based on an algorithm.

Step 306 trains the weighted candidate prediction functions based on training sample 204, which involves applying the candidate prediction algorithm/estimator to the training sample.

Step 308 validates the trained prediction functions based on validation sample 206. In this case, inputs to the trained prediction functions are provided and the outcomes are generated. The known outcomes of validation sample 206 are then used to validate the trained prediction functions.

Step 310 then determines if different weight combinations should be used in the training process. If so, the process reiterates to step 304 in which different weighted combinations are determined. The process then continues as the candidate prediction functions are re-trained using the different weighted combinations.

If different weight weighted combinations are not needed, step 312 evaluates the different weight weighted combinations for the trained candidate prediction functions. For example, the optimal weighted combination is selected in step 314. The optimal weighted combination may be the weighted combination that resulted in predicted outcomes that most closely match the known outcome. Using the weighted combination, data adaptive prediction function 104 is output. For example, the mapping of the data to determine the weighted combination for candidate prediction functions 106 forms the basis of data adaptive prediction function 104.

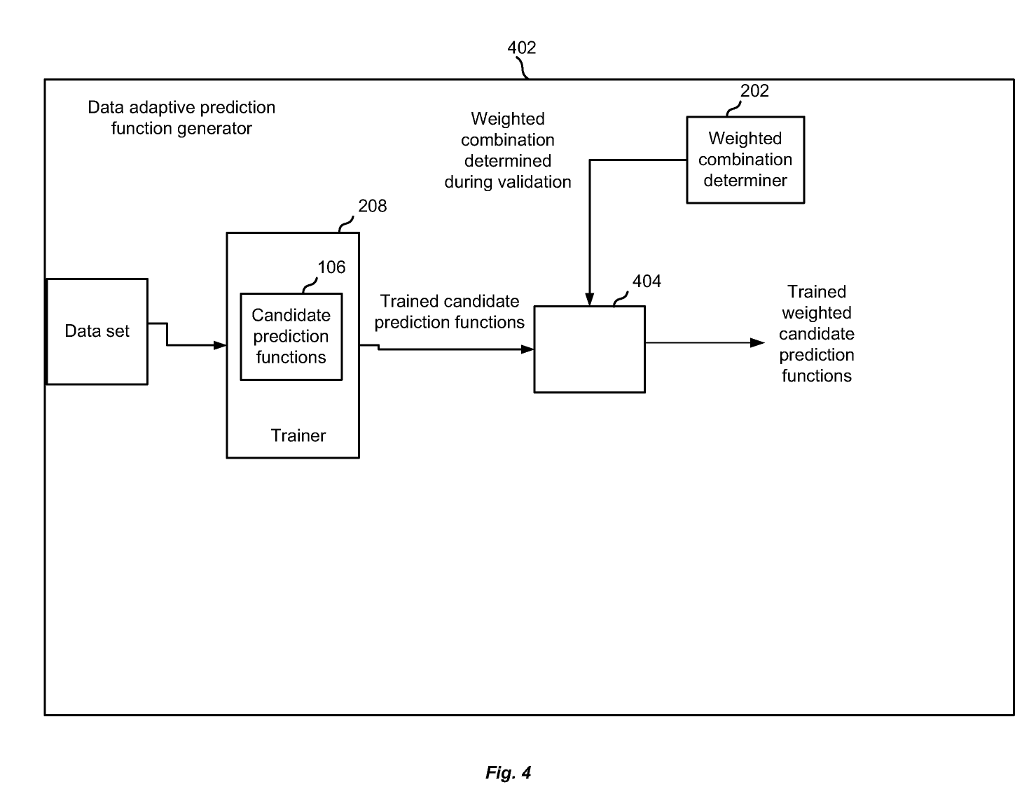

After the weighted combination is determined, candidate prediction functions 104 may be trained on the data set. In the validation, candidate prediction functions were trained on a split of data (e.g., 800 out of 1000 samples). Thus, the whole data set may be used to train candidate prediction functions. FIG. 4 depicts a simplified system for generating data adaptive prediction function 104 according to one embodiment. A data adaptive prediction function generator 402 is used to generate data adaptive prediction function 104.

The whole data set may be input into trainer 208. Candidate prediction functions 106 may be trained based on the data. As discussed above, the training maps the data into a prediction function. The candidate prediction functions may be algorithms or estimators that are programmed to predict an output. Without data, these algorithms may be generic estimators. When trained with a data set, the estimators are programmed to estimate an outcome based on the data set.

After being trained on the data set, the weighted combination determined by weight generator 202 is combined with the trained candidate prediction functions in 404. The weighted combination may be different kinds of combinations that may be any combination of the outcomes. For example, the combination may be the average of the weighted outputs or any other combination. This forms the basis for data adaptive prediction function 104, which may be output to a user or application for use in determining a predicted outcome.

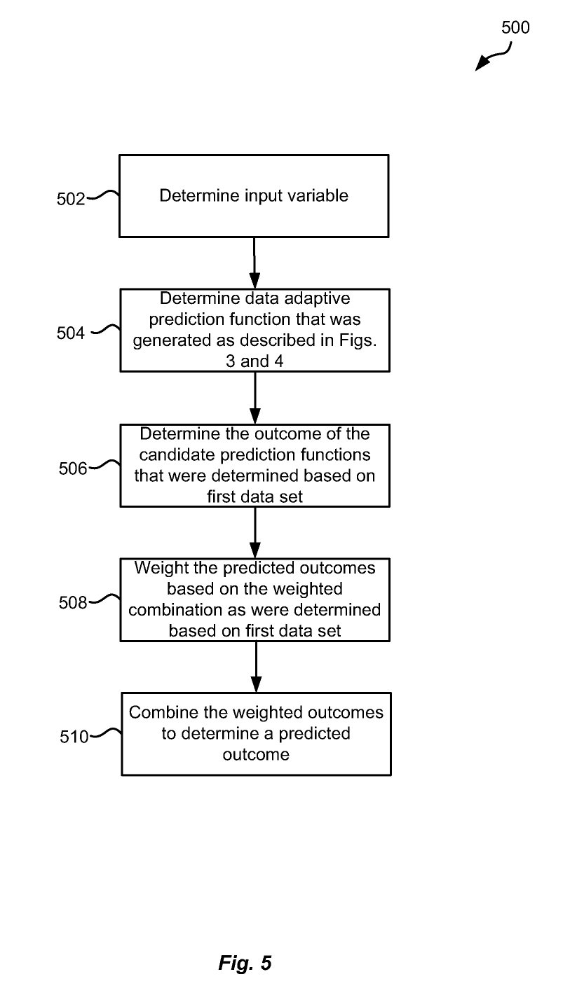

FIG. 5 depicts a simplified flowchart 500 of a method for determining a predicted outcome according to one embodiment. After training the candidate prediction functions 106 on a known data set, determining the weights based on this known data set, and generating the resulting data adaptive prediction function 104, a new data set may be determined in step 502. In this case, input variables may be mapped to a predicted outcome. The data set may be for the same experiment in which the data set that was used to determine the weights. Thus, the data adaptive prediction function is adapted to be optimized for the data set that is being tested.

Step 504 determines data adaptive prediction function 104 that was generated as described in FIGS. 3 and 4. Data adaptive prediction function 104 includes the weights determined from first data set that should be used. The weights determined may be based on the result of the method performed in FIG. 3. Also, the trained candidate prediction functions 106 are determined that were trained on the first data set.

Step 506 determines the outcome of the candidate prediction functions that were determined based on first data set. For example, input variables for the data set are input into the candidate prediction functions from first data set, which output predicted outcomes. Step 508 then weights the predicted outcomes based on the set of weights as were determined based on first data set.

Step 510 then combines the weighted outcomes to determine a predicted outcome

Particular embodiments will now be described in more detail. Various examples of prediction algorithms may be used that map a data set into such a data adaptive prediction function combining these candidate algorithms without relying on a particular a priori specified parametric form indexed by a finite dimensional set of weights)

Given a set of candidate prediction functions, V-fold cross-validation is a statistical tool for selecting among these candidate prediction algorithms which 1) splits the sample in V subgroups thereby providing V ways of splitting the sample in a validation sample (one of the subgroups) and training sample (the remaining V-1 subgroups), 2) applies each candidate prediction algorithm to the training sample and evaluates the prediction performance of its resulting fit on the validation sample, and 3) selects the algorithm with the best cross-validation performance across the V sample splits.

Weight generator 202 uses V-fold cross-validation to data adaptively select a set of optimal weights to combine the given set of candidate prediction functions into data adaptive prediction function 104. The data adaptive prediction function performs asymptotically (i.e. for large samples) at least as well as any of the weighted combinations of the candidate algorithms.

In one embodiment the computational speed of the weight generator and thereby the data adaptive prediction function is of the same order as the amount of computer time needed to run each of the candidate prediction functions. This data adaptive prediction function applies not only to prediction but it applies to any parameter (typically representing a whole function of e.g. input variables) of the data generating distribution that can be defined as a minimizer, over candidate parameter values in a parameter space, of an expectation of a loss function, where a loss function is a function of the data structure on the experimental unit and the parameter. In fact, it can be generalized to arbitrary criterions representing a function of the data and a candidate parameter value.

Cross-validation divides the available data set into a training set and a validation set. Observations in the training set are used to construct (or train) the candidate estimators, and observations in the validation set are used to assess the performance of (or validate) these candidate estimators. In v-fold cross-validation, the learning sample (i.e., the data set) is divided into v mutually exclusive and exhaustive sets of as nearly equal size as possible. Each set and its complement play the role of the validation and training sample, respectively, giving v splits of the learning sample into a training and corresponding validation sample. For each of the v splits, each weighted combination of the candidate prediction functions weights is applied to the training set, and its risk (i.e., performance, low risk is good performance) is estimated with the corresponding validation set. For each weighted combination of the candidate estimators the v risks over the v validation sets are averaged resulting in the so-called cross-validated risk. The weight with the minimal cross-validated risk is selected.

Each candidate prediction function may be an algorithm applied to empirical distributions or simply the data set. Thus, a candidate prediction function can be represented as a function from the empirical probability distribution to a prediction function that can be used to map input variables into a predicted outcome. For each set of weights, a weighted combination of the candidate prediction functions is defined. The data adaptive prediction function may now be defined as the estimator identified by the cross-validation selector described above which simply selects the weighted combination of the candidate prediction functions that performed best in terms of cross-validated risk.

A theorem under the assumption that loss function L(O,psi) (e.g. (Y-psi(X))̂2) is uniformly bounded in the observation O and the parameter psi, and the Assumption A2 that the variance of the psi_{—}0-centered loss function L(O,psi)-L(O,psi_{—}0), with psi_{—}0 denoting the true parameter, can be bounded by its expectation uniformly in psi, a finite sample inequality is established. In this theorem presenting the finite sample inequality, the oracle selector is defined as the estimator, among all the weighted combinations of the candidate prediction functions considered, which minimizes risk under the true data-generating distribution. In other words, the oracle selector selects the weighted combination that is considered optimal. Optimal may be the closest combination that could be determined to be optimal if the true data generating experiment was known. The oracle selector may be the prediction function that could be considered the benchmark theoretically. For example, if a data set was large enough, it would theoretically result in the oracle selector.

Applied to the data adaptive prediction function, this theorem shows that the data adaptive prediction function performs as well (in terms of expected risk difference) as the oracle selector, up to a typically second order term. A consequence of this theorem is that, as long as the number of candidate prediction functions considered (K(n)) is polynomial in sample size and the candidate prediction functions are uniformly bounded, the data adaptive prediction function is the optimal prediction function in the following sense:
If, as is typical, none of the weighted combinations of the candidate prediction functions considered (nor, as a result, the oracle selector) converge at a parametric rate as a function of sample size, the data adaptive prediction function performs asymptotically as well (in the risk difference sense) as the oracle selector, which chooses the best of the weighted combinations of the candidate learners.
If one of the candidate prediction functions happens to search among a parametric/small subspace that contains the truth, and thus achieves a parametric rate of convergence, then the data adaptive prediction function achieves the almost parametric rate of convergence log n/n to the truth in sample size n.

Particular embodiments formulate the minimization of cross-validated risk over this family of a continuum of candidate prediction functions indexed by weights as another regression problem for which one can select an appropriate regression methodology (e.g. involving cross-validation or penalized regression) to determine the optimal weights. By this formulation as a regression problem, data adaptively determining a particular family of weighted combinations of the candidate prediction function scan involve controlling overfitting of the cross-validated risk through the use of data adaptive regression algorithms.

Particular embodiments offers advantages by extending the set of candidate prediction functions into a large family of candidate prediction functions that is obtained by combining the candidate prediction functions according to a (possibly data adaptively determined) parametric or semi-parametric model with a weight parameter, thereby obtain a potentially much stronger data adaptive prediction function. In addition, these gains come at no cost regarding computing time. The practical performance is improved for the data adaptive prediction function based on simulated as well as a number of benchmark real data sets illustrating its adaptivity to the true unknown optimal prediction function by picking the right combination of algorithms across different sets of data generating experiments.

As described above, a weighted combination is determined. Weight determiner 210 defines some form of linear combination, such as a weighted average, of the J initial candidate prediction functions, where each linear combination defined by a coefficient/weight vector. This coefficient vector is referred to as a vector of weights, but there is no requirement that these weights add up till 1, that they are positive valued, or that each candidate learner gets a single weight assigned: i.e., the coefficient vector can be of larger or shorter dimension than the number of candidate estimators/algorithms.

Each weight vector identifies a new data adaptive prediction function represented by this weighted average of the initial candidate prediction functions. For each weight vector the V-fold is computed as cross-validated risk as described above. The weight is selected which minimizes the cross-validated risk which identifies a new data adaptive prediction function that minimizes the cross-validated risk over all weighted combinations of the initial set of candidate prediction functions. Particular embodiments now note also that this weight vector minimizing the cross-validated risk can be computed is itself a solution of a newly formulated regression problem.

Particular embodiment will now be described in more detail. Supposing the data set includes n observations O_i=(X_i,Y_i), i=1, . . . ,n, and a true regression psi_{—}0(X)=E_{—}0(Y|X) of representing the conditional mean of the outcome Y on input variables X, i.e. the conditional mean of Y given X. This true unknown regression function Psi_{—}0(X) can be defined as the minimizer of the expectation of the squared error loss function with respect to the true data generating distribution, among all candidate prediction functions psi:

psi_{—}0=arg min_psi E_{—}0L(O,psi),

where L(O,psi)=(Y-psi(X))̂2 and psi denotes a candidate prediction function (i.e. function of input variables X). The super-learning algorithm, i.e. the data adaptive prediction function, immediately applies to any parameter which can be defined as a minimizer of a loss function L(O,psi) over a parameter space, but, in order to be specific, the prediction problem is focused on using this squared error loss function.

The data adaptive prediction function is not restricted to independent and identically distributed observations with common distribution P_{—}0. It can also be generalized to any empirical criteria. For example, the cross-validated risk (defined by empirical average over validation sample of a loss function at a candidate prediction functions over training sample, and then averaged over the V sample splits in validation and training sample) can be replaced by the cross-validated version of any empirical criteria evaluating the performance of a candidate prediction function over a (validation) sample.

Let Psi_j,j=1, . . . ,J, be a collection of J candidate prediction functions, which represent mappings (algorithms) from the empirical probability distribution into the parameter space consisting of prediction functions of X. The data adaptive prediction function uses V-fold cross-validation. Let v be an integer {1, . . . ,V} which indexes a sample split into a validation sample V(v) and training sample (the complement of V(v)) T(v). The union of the validation samples equals the total sample, and the validations samples are disjoint. For each v, let, psi(njv) be the realization of the j-th estimator when applied to the training sample T(v).

Let Psi(alpha)(X)=m((Psi_j(X):j),alpha) be a new data adaptive prediction function obtained by taking a particular weighted combination of the j-specific predicted values Psi_j(X) indexed by “weight” vector alpha. Thus Psi(alpha) is now a family of prediction algorithms indexed by a coefficient/weight vector alpha. The output of evaluator 214 is to find the choice alpha* that minimizes the cross-validated risk of the candidate prediction function Psi(alpha) over all possible values of alpha.

For an observation i, let v(i) denote the validation sample it belongs to, i=1, . . . ,n. A new data set of n observations is constructed as follows: (Y_i,Z_i), where Z_i=psi(njv(i))(X_i):j=1, . . . ,J) is the vector consisting of the J predicted values according to the J estimators trained on the training sample P_{nT(v(i))}, i=1, . . . ,n. This data set is referred to as the cross-validated data set. The alpha* is the minimizer of sum_i (Y_i-m(Z_i,alpha))̂2 and thereby that it can be calculated with standard least squares software.

### Minimum Cross-Validated Risk Predictor:

Above a functional form m(Z,alpha) specifies how each choice of alpha combines the J predicted values of the J initial predictors into a new predicted value. This functional form does not need to be a priori specified but that instead a data adaptive regression algorithm is run to the cross-validated data set thereby regressing Y_i onto Z_i, which then data adaptively selects a particular functional form m(Z,alpha) and coefficient alpha*. That is, another input of this data adaptive prediction function methodology is a user supplied prediction algorithm, which estimates the regression of Y onto Z based on the data set (Y_i,Z_i), i=1, . . . ,n, which could be a model based least squares regression as above.

This is referred to as the minimum cross-validated risk predictor since it aims to minimize the cross-validated risk, sum_{i=1}̂n(Y_i-m(Z_i))̂2$, over a set of candidate prediction functions m from a set of prediction values Z into a predicted outcome, although, penalization or cross-validation is allowed to avoid over-fitting of this cross-validated risk criteria. This predictor will now determine a function m_n, possibly of the type m_n(Z)=m(Z,alpha_n) for a specified functional form m(Z,alpha) indexed by coefficient vector alpha.

The predictor for a value X based on the data is now given by m_n(Psi_n{jn}(X):j), i.e. m_n applied to the predicted values of the initial candidate prediction functions now applied to the whole sample. In other words, the predictor of Y for a value X is obtained by evaluating the predictor m_n at the J predicted values, psi_{jn}(X), at X of the J initial candidate estimators. A specified model m(Z,alpha) could also estimate alpha with a constrained least squares regression estimator such as penalized L_{—}1-regression (Lasso), penalized L_{—}2 regression (shrinkage), where the constraints are selected with cross-validation, or one could restrict alpha to the set of positive weights summing up till 1.

As mentioned above, there is no need to restrict m_n to parametric regression fits. For example, m_n could be defined in terms of the application of a particular data adaptive (machine learning) regression algorithm to the data set (Y_i,Z_i), i=1, . . . ,n, such as classification and regression trees (CART), the deletion/substitution/addition regression algorithm (DSA), and polynomial spline regression (MARS), among others. Also, a super-learning algorithm could be applied itself to estimate the regression of Y onto Z. In this manner the data can be used to build a good predictor of Y from predicted values of the initial candidate prediction functions.

The data adaptive prediction function is indexed by the choice of initial candidate prediction functions, and a choice of minimum cross-validated risk predictor that finds the regression of Y onto Z based on the cross-validated data set. As a consequence, given the set of initial candidate prediction functions, particular embodiments provide a whole class of tools indexed by an arbitrary choice of regression algorithm for this regression of Y onto Z to map an initial set of candidate prediction functions into a new data adaptive prediction function. In particular, it provides a new way of using the cross-validated risk function, which goes beyond minimizing the cross-validated risk over a finite set of candidate prediction functions.

One benefit of the data adaptive prediction function methodology is obtained by selecting a large variety of candidate prediction algorithms relying on different strategies for constructing a prediction of an outcome. The data adaptive prediction function methodology allows prediction generator 102 to combine a plurality of candidate prediction functions into a single method data adaptively for each data set at hand. Methods such as dimension reduction, the amount of reliance on extrapolation (global versus local smoothing), and the type of basis functions are used to construct the data adaptive prediction function.

For example, dimension reductions of the input variables can be based on univariate associations with the outcome, targeted maximum likelihood estimators of the variable importance for each of the variables, cluster analysis, or principal component analysis, etc.

Candidate prediction functions can range from global smoothers relying on extrapolation, i.e. algorithms using all observations when making a prediction for a particular input x, to local smoothers, i.e. algorithms which only use observations close to x to make this prediction. By having such algorithms representing different dimension reduction strategies and smoothing strategies as candidates the data adaptive prediction function asymptotically finds the optimal balance between these different strategies thereby outperforming each of these algorithms.

Although the description has been described with respect to particular embodiments thereof, these particular embodiments are merely illustrative, and not restrictive. Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for predicting an outcome, the method comprising:
determining a known data set of data, the known data set of data including an input variable and an output variable;
determining a plurality of candidate prediction functions, each prediction function adapted to determine a candidate predicted outcome for the output variable using a different algorithm;
determining a combination of the plurality of candidate prediction functions based on the known data set;
determining a second set of data, the second set of data including data for the input variable; and
determining, based on the input variable, a predicted outcome for the output variable using a data adaptive prediction function, wherein the data adaptive prediction function uses the combination of candidate predicted outcomes from the plurality of candidate prediction functions determined using the data from the input variable to determine the predicted outcome.

2. The method of claim 1, wherein the combination comprises a function of combining the outputs of the plurality of candidate prediction functions.

3. The method of claim 1, further comprising training the plurality of candidate prediction functions on the known data set and applying the determined combination of the plurality of candidate prediction functions to trained candidate prediction functions to generate the data adaptive prediction function.

4. The method of claim 1, wherein the combination weights candidate prediction functions in a weighted combination to more accurately predict the output variable based on the known data set.

5. The method of claim 3, wherein determining the combination of the plurality of candidate prediction functions comprises using cross validation to determine a weighted combination of the plurality of candidate prediction functions.

6. The method of claim 5, further comprising:
splitting the known data set into a training set and a validation set;
training the plurality of candidate prediction functions using the training set and a weighted combination;
determining predicted outcomes for the plurality of trained prediction functions using different weighted combinations; and
evaluating the predicted outcomes using the validation set.

7. The method of claim 6, further comprising:
reiteratively training the plurality of candidate prediction functions with the training set and different weighted combinations.

8. The method of claim 1, wherein the known data set and the second data set are determined for a similar set of controlled conditions.

9. The method of claim 8, wherein the set of controlled conditions comprises a scientific experiment.

10. The method of claim 1, wherein the input variable comprises data input into the plurality of candidate prediction functions in which a causal effect is desired.

11 The method of claim 1, wherein the output variable comprises a variable in which the data adaptive prediction function predicts using the input variable.

12. A method comprising:
determining a known data set of data;
determining a plurality of candidate prediction functions, each candidate prediction function trained using the data set using a different algorithm;
determining different weighted combinations for the plurality of candidate prediction functions based on the data set;
evaluating the different weighted combinations to select a weighted combination;
determining a data adaptive prediction function configured to predict an outcome for a second data set using the plurality of candidate prediction functions and the weighted combination; and
outputting the determined data adaptive prediction function.

13. The method of claim 12, wherein determining the data adaptive prediction function comprises training the plurality of candidate prediction functions on the data set and applying different weighted combinations to the trained candidate prediction functions.

14. The method of claim 12, wherein the weighted combination weights candidate prediction functions in a weighted combination to more accurately predict the output variable based on the known data set.

15. The method of claim 14, wherein the weighted combination is selected using cross validation.

16. The method of claim 15, further comprising:
splitting the known data set into a training set and a validation set;
training the plurality of candidate prediction functions using the training set and a weighted combination;
determining predicted outcomes for the plurality of trained prediction functions using different weighted combinations; and
evaluating the predicted outcomes using the validation set.

17. The method of claim 16, further comprising:
reiteratively training the plurality of candidate prediction functions with the training set and different weighted combinations.

18. The method of claim 12, wherein the selected weighted combination is determined based on an evaluation of risk of different sets of weights and the different sets of weights effect on predicted outcomes of the data adaptive prediction function.

19. An apparatus comprising:
one or more processors; and
logic encoded in one or more tangible media for execution by the one or more processors and when executed operable to:
determine a known data set of data, the known data set of data including an input variable and an output variable;
determine a plurality of candidate prediction functions, each prediction function adapted to determine a candidate predicted outcome for the output variable using a different algorithm;
determine a combination adjustment for the plurality of candidate prediction functions based on the known data set;
determine a second set of data, the second set of data including data for the input variable; and
determine, based on the input variable, a predicted outcome for the output variable using a data adaptive prediction function, wherein the data adaptive prediction function uses the combination adjustment of candidate predicted outcomes from the plurality of candidate prediction functions determined using the data from the input variable to determine the predicted outcome.

20. An apparatus comprising:
one or more processors; and
logic encoded in one or more tangible media for execution by the one or more processors and when executed operable to:
determine a known data set of data;
determine a plurality of candidate prediction functions, each candidate prediction function trained using the data set using a different algorithm;
determine different weighted combinations for the plurality of candidate prediction functions based on the data set;
evaluate the different weighted combinations to select a weighted combination;
determine a data adaptive prediction function configured to predict an outcome for a second data set using the plurality of candidate prediction functions and the weighted combination; and
output the determined data adaptive prediction function.
